(19) United States
(12) Patent Application Publication
(10) Pub. No.: US 2015/0077382 A1
(43) Pub. Date: Mar. 19, 2015

(54) Touch Circuit Architecture

(71) Applicant: Inputek Co., Ltd, Hsinchu County (TW)

(72) Inventors: Chang Kuang CHUNG, Hsinchu County (TW); Sheng Chang KUO, Hsinchu County (TW)

(73) Assignee: Inputek Co., Ltd, Hsinchu County (TW)

(21) Appl. No.: 14/031,959

(22) Filed: Sep. 19, 2013

(51) Int. Cl. G06F 3/044

(52) U.S. Cl. CPC G06F 3/044
USPC 345/174

(57) ABSTRACT

A projected capacitive touch panel comprises a triangle waveform generator, a plurality of analog switches, a plurality of sample and hold circuits. In addition, it also comprises a single conductive layer and flexible printed connectors. The single conductive layer is made of many sensing lines with high resistance. A triangle waveform is generated by the triangle waveform generator. The triangle waveform is transmitted to the sensing lines via the plurality of analog switches. In a rising stage, the plurality of sample and hold circuits are in their hold state. In a declining stage, the sample and hold circuits are in their sample state. The sample and hold circuit collects voltage deviation depending on resistance deviation on a sensing line. And higher resistance deviation can induce higher deviation voltage in the sensing line.

### FIELD OF THE INVENTION

The present invention relates to a capacitive touch system. More specifically, it is a touch circuit architecture design with a high resistance conductive layer touch sensor, which is particularly suitable for the large size touch applications.

### BACKGROUND OF THE INVENTION

The touch screen technology has been used in a wide variety of different areas and applications, such as mobile phone, tablet computer, game console, and screens of many other devices. A touch screen is an electronic visual display that the user can control through simple or multi-touch gestures by touching the screen with one or more fingers. Some touch screens can also detect objects such as a stylus or ordinary or specially coated gloves. The touch screen technology is very popular because it enables the user to interact directly with what is displayed, rather than using a mouse, touchpad, or any other intermediate device.

While they all can achieve the same result, there are a variety of different touch screen technologies that can accomplish the touch sensing. These technologies comprise resistive touch panel, surface acoustic wave touch panel, capacitive touch panel, infrared grid touch panel, optical touch panel, and etc. Recently, the capacitive touch panels have become more popular after the releases of new smart phones and tablets.

Capacitive touch panels can be classified into surface resistive touch panels (single-touch) and projected capacitive touch panel (multi-touch). The projected capacitive touch panels (PCT) are able to detect multiple touches, and simultaneously to enlarge, narrow, rotate or drag a pattern on a projected capacitive touch panel, which are very convenient and useful for users. In addition, the projected capacitive touch panels overcame disadvantages in resistive touch panels to avoid wearing out the resistive touch panels.

All PCT touch screens are made up of a matrix of rows and columns of conductive material, layered on sheets of glass. This can be done either by etching a single conductive layer to form a grid pattern of electrodes, or by etching two separate, perpendicular layers of conductive material with parallel lines or tracks to form a grid. Voltage applied to this grid creates a uniform electrostatic field, which can be then measured. When a conductive object, such as a finger, comes into contact with a PCT panel, it distorts the local electrostatic field at that point. This is measurable as a change in capacitance. If a finger bridges the gap between two of the tracks, the charge field can be further accurately interrupted and detected by a microcontroller unit.

The capacitance can be changed and measured at every individual point on the grid (intersection). Therefore, this system is able to accurately track touches. Due to the top layer of a PCT being glass; it is a more robust solution than the less costly resistive touch technology. Additionally, unlike traditional capacitive touch technology, it is possible for a PCT system to sense a passive stylus or gloved fingers.

As discussed above, the most popular technology in Projected Capacitive Touch (PCT) is the Axis Intersect (AI) technology. In this method, it needs two axes; wherein one is the vertical line for transmit signal, while the other is the horizontal line functions for sensing the electrical charge variation, in order to distinguish the cross point that has been touched.

In this technology, normally two conductive layers of sensors are needed to carry out the normal function. One is for the vertical lines and the other is for the horizontal lines. These two layers are pasted together by using an adhesive material to become a complete PCT touch sensor panel. Apparently, in such a technology, the accurate alignment is a critical factor for the quality and proper function of the PCT panel. In this existing technology, usually the low resistance sensor pattern is used. On the other hand, in the circuit, a square waveform is used. Accordingly, it is one principal objective of the present invention to improve such technology, and with the purpose of simplifying the PCT technology, reducing the negative impact due to a poor alignment, as well as making the PCT technology suitable for a number of currently popular application areas, such as the very large size touch panel, and the very small nano carbon tubes as well.

### BRIEF DESCRIPTION OF THE DRAWINGS

FIG. 1 is a schematic illustration of the circuit architecture of the present invention.

FIG. 2 is a schematic illustration of the touch system that comprises the circuit disclosed in the present invention.

FIG. 3 is a schematic illustration of the waveforms in the operation.

FIG. 4 is a schematic illustration of the variation of electrical charges of the present invention.

### DETAILED DESCRIPTION OF THE INVENTION

All illustrations of the drawings and description of embodiments are for the purpose of describing selected versions of the present invention and are not intended to limit the scope of the present invention.

In order to achieve the main objective of the present invention, two key parts of the PCT technology have been improved. One is to make the signal transmitted to the sensing line in a triangle waveform. In the present invention, the transmitted signal can be the triangle waveform alone; or it can be a combination of any waveform plus the triangle form. Herein the waveform is significantly different from the waveform of the signal in the common PCT technologies. While in the common PCT technology, such signal is normally transmitted in the form of square waveform. Moreover, the other difference is that the sensing lines in the touch panel of the present invention become the high resistance sensing line. In the sensor pattern design used the technology of the present invention, the higher the resistance per sensing line, the better the sensing activity. In addition, as for the touch panel structure, it only has one conductive layer of indium tin oxide (ITO).

The design of the present invention is associated with a few significant beneficial effects. The PCT touch panel disclosed in the present invention is suitable for the large size touch panel device. In the present invention, the touch panel structure has a single layer of ITO. Therefore, there is no need to do the alignment of the two ITO layers with the horizontal and vertical lines, respectively. It is easily understood that the bigger the touch panel size, the more complex to make the alignments of the two ITO layers. Besides, the lamination work for the big screen would be more complicated, too; whereas in the present invention, since there is only one ITO layer, both the alignment and lamination are now unnecessary.

Further, the sensing line or sensing bar is specifically designed as the high resistance one. Usually, the large size touch panel means the sensing line on the ITO layer is pretty long. Therefore, the resistance will be higher in such a case. Moreover, the touch panel in the present invention is very suitable for certain popular new materials, such as the nano carbon tube. Because the nano carbon tube is a high resistance material (the resistance of nano carbon tube is much higher than the common ITO).

In the common model of the PCT operation, PCT touch sensor is composes by vertical and horizontal conductive layers and a dielectrical layer insert in between the two conductive (dialectical) layers to avoid a short circuit. Such a structure is actually a capacitor. Thus, if a signal is transmitted from horizontal line, a coupled voltage will be generated on the corresponding vertical line, which is due to the dielectrical coupling effect. When a finger is touched on cross point, the capacitor is changed (dielectrical capacitor plus human finger capacitor), the coupling voltage on vertical will be small than un-touched. This is the operation model on a common PCT.

In the above mentioned common PCT touch panel, a low resistance sensing line has to be used for the touch panel. In a sensing line, periodical square wave is transmit from a node, because of the issue of the ITO resistance, the waveform on node B will be a little bit different from that of that of that node. And the higher the sensing line resistance is, the bigger the difference is. In this scenario of the conventional PCT touch panel, if using a high resistance sensing line, the coupling voltage on each vertical sensing line will be very different. And it will become a big problem for the determination that whether the sensing node on that sensing line has been touched. Therefore, in the conventional PCT touch sensor design, low resistance conductive is a must in order to reduce the coupling voltage offset issue. However, in the present invention, due to the different working mechanism (the PCT technology of the present invention has been developed on the basis of both the common PCT technology and the surface capacitive touch (SCT) technology). In the present invention, the higher conductive resistance on each sensing line is better. It is noted herein that the sensing line in the present invention is the ITO pattern on the touch panel. Sometimes, it is also called sensing bar. This is different from the connection line that links the touch panel element to its respective controller or circuit.

Commonly, a PCT uses X, Y scan algorithm to address the touch position. In present invention, only X direction can be easily reported. Y direction need use sample & hold circuit to collect the voltage deviation depending on resistance deviation on a sensing line. Higher resistance deviation can induce higher deviation voltage in a sensing line. This is how the touching location has been determined in the present invention.

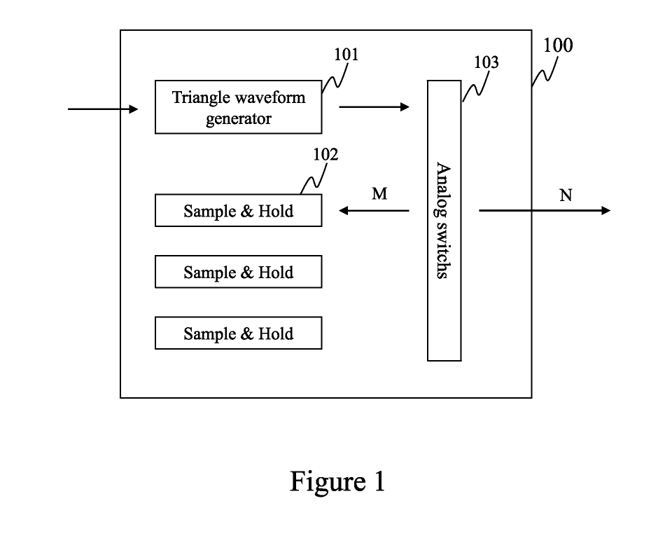

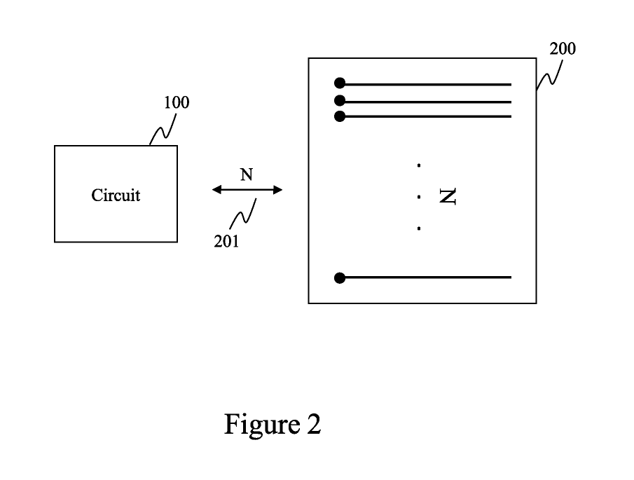

In reference to FIGS. 1 to 4, concerning the touch control circuit of the present invention, the triangle waveform is used to replace square wave as the signal source to be transmitted to the sensing line. This is different from the square waveform used in the normal PCT control signal. The control signal for the sensing line of the touch panel is generated from the circuit architecture 100. This circuit comprises a triangle waveform generator 101; a plurality of sample and hold circuits 102, and a plurality of analog switches 103. The sample and hold circuit is an analog device that samples (captures, grabs) the voltage of a continuously varying analog signal and holds (locks, freezes) its value at a constant level for a specified minimum period of time. An analog switch, also called the bilateral switch, is an electronic component that behaves in a similar way to a relay, but has no moving parts. The switching element is normally a pair MOSFET transistor, one an N-channel device, the other a P-channel device. The device can conduct analog or digital signals in either direction when on and isolates the switched terminals when off. In the present invention, the number (quantity) of the sample and hold circuits has been set as M, and the number (quantity) of the analog switch is N. In addition, in the present invention, each analog switch is connected to a sensing line in a touch panel. And such sensing lines are the high resistance sensing lines. A touch panel may have N or more than N sensing lines. This new circuit for control single is connected to the touch panel 200 by its N number of analog switches via an electrical wire 201, to a sensing line in the touch panel. The analog switch in the present invention is the IO pin in touch control. They connected to touch panel by means of FPC (Flexible Printed Connector). The sensing lines in touch panel are connected to FPC by copper or silver lines.

During the operation, first, an input signal 300, a constant frequency signal, is sent to the triangle waveform generator 101. The input signal 300 is a periodic clock (square waveform) from MCU (microcontroller unit); white the clock rate (frequency) is controlled by the firmware design. Next, the triangle waveform generator will output a triangle waveform or a semi-triangle waveform 301 to the above mentioned analog switch 103. On the rising edge (stage A) of the triangle waveform, the selected sensing line connecting to the analog switch will be charged by the triangle waveform control signal. The signal is transmitted to the touch point 302 (connecting to the finger) for the purpose of charging the capacitor on 302. Later, on the falling edge (stage B) of the signal transmission, the electrical charge will go to the opposite direction via the analog switch to the respective sample and hold circuit, i.e., the signal transfers the capacitor charge from the finger 302 to the sample and hold circuit, and meanwhile the triangle waveform generator 101 will be discharged quickly for preparation on next rising edge. On the other hand, the electrical charge on selected sensing line will be transfer to a corresponding sample and hold circuit 102. And within a period of time, the electrical charge on sample and hold circuit will be saturated.

More specifically, when the touch panel is untouched, the sample and hold circuit outputs a holding voltage (VH). The Cpar will be the parasitic capacitance from the analog switch, PFC to the sensing line. While when the touch panel has been touched, at the near end (the terminus on a sensing line, which is close to analog switch), Ctot=Cpar+Cfin, wherein Cfin is finger's capacitor, while at the far away end (the terminus on a sensing line, which is far away from the analog switch). The key design in the present invention is that by sing a high resistance sensing line, it will induce a higher latency time for charging the Ctot, the latency time T=1/(Rsen×Ctot). Assuming that the Ctot is constant, the Rsen (resistance on touched position) will be different. Assuming the finger touching location 302 has a capacitor Cfin; and the sample and hold circuit has a holding capacitor Cpar. In stage A, the triangle waveform produces the charge to the finger touching location 302, then the total charge on location 302 is Cfin×V(tri). In the stage B, the charge will be transferred to Cpar, if the charge is lossless in all the activities, the holding voltage will be Cfin×V(tri)/(Cfin+Cpar), after Hundreds of clock cycles, the holding voltage will be saturated, and the VH is the saturated holding voltage. The VH will be variable depending on the touched position on the selected sensing line. Therefore, a higher resistance sensing line can have a better change to distinguish the touched positions.

In addition, in the stage A, the sample and hold circuits are acting the hold function. In the stage B, the sample and hold circuits are acting the sampling function to collect the charge from the finger touching location 302.

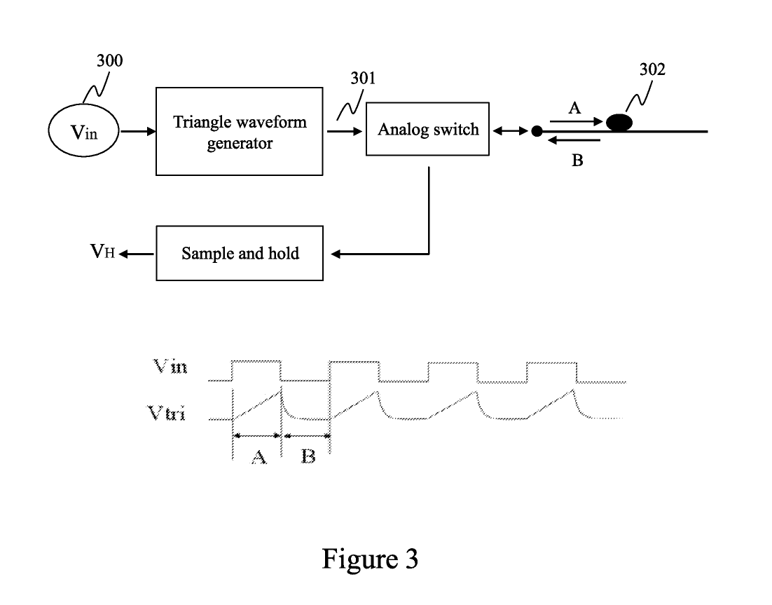

In this way, as mentioned above, the sensing liens are the high resistance sending lines in the present invention. Thus, as shown in FIG. 3, for a high resistance sensing line, the impedance from various signal nodes to the touch point 302 are different. With a constant frequency, the saturated electrical charge will be different, which is dependent on the various touch points. According to the various electrical charges, the touch point can be determined based on the charging information at the respective analog switches 103, similarly, the selected sensing line will also be known. Therefore, the location that has been touched can be determined in this touching panel technology.

In conventional PCT technology, it uses the X, Y scan algorithm to determine the touch position. While in the present invention, only the X direction can be easily reported. The Y direction needs use sample & hold circuit to collect the voltage deviation depend on the resistance deviation on a respective sensing line. A higher resistance deviation can induce higher deviation voltage in a sensing line.

For a touch panel device following the design disclosed in the present invention, it would operate in the way described below. A touch panel comprising N (or close to N) sensing lines in its touch panel, and M sample and hold circuits in its control signal circuit. The number of M sensing line can be charged simultaneously and 1≦M≦N. It is noted that generally there is one triangle wave generator circuit in a chip. A plurality of M sample and hold modules in a chip. The analogue switch is (2, 4, 8, and 16) times of the sample and hold circuit depending on the decoder in a chip. Usually, the sample and hold module (M) will be defined first. Analog switch (N) is the IP pin in a chip, for easy decoder design N will be 2×M, 4×M, or 8×M, depending on the factors such as the IO pin count in a package, the charging time in sample and hold module, and etc. Normally the sample and hold module (M) will dominate the die size on a chip, while the analog switch (N) would be design as a multiple of M. The sensing line (X) related to N: for example X=60, N=40, then 2 chips are needed to meet all sensing lines that need to be detected. The best scenario is that X=N or X is a little bit smaller yet very close to N. A chip with M sample and hold module and N analog switch connect to the component 200, only number of M sensing line will be selected simultaneously, others sensing lines will be floating or tie to ground.

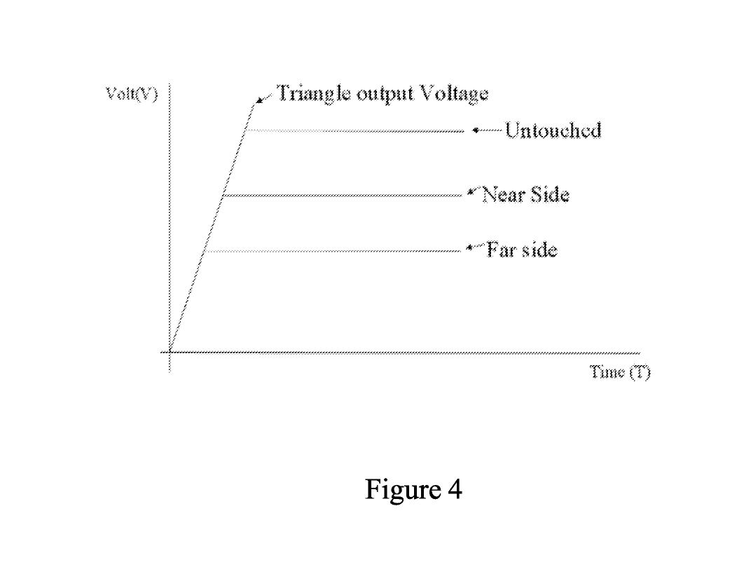

Accordingly, if a respective sensing line is with 10R impedance, the capacitor on human body is Ch, the parasitical capacitor on sensing line is Cp. In the case when the respective sensing line is not touched, the charging time will be 1/(R×Cp). When it is touched on the part near the signal source, the charging time will be 1/(R×(Cp+Ch)); while when the end far away from the signal source is touched, the charging time will be 1/(10×R×(Cp+Ch)). Thus, when the input control signal frequency in the constant triangle waveform is higher than 1/(R×Cp), the saturated electrical charge on sample and hold circuit will be different. The voltage variations on sample and hold circuit are shown as FIG. 4.

Although the invention has been explained in relation to its preferred embodiment, it is to be understood that many other possible modifications and variations can be made without departing from the spirit and scope of the invention as herein described.

What is claimed is:

1. A projected capacitive touch panel architecture, comprising
a projected capacitive touch circuit;
a touch sensor panel; and
a connection between said projected capacitive touch circuit and said touch sensor panel.

2. The projected capacitive touch panel architecture of claim 1, wherein said projected capacitive touch circuit comprising
a triangle waveform generator;
a plurality of analog switches; and
a plurality of sample and hold circuits.

3. The projected capacitive touch panel architecture of claim 2, wherein said touch sensor panel comprising
a single conductive layer;
said single conductive layer comprising a plurality of sensing lines with high resistance.

4. The projected capacitive touch panel architecture of claim 3, wherein said connection comprising
one or a plurality of flexible printed connectors (FPCs); and
said plurality of sensing lines being connected to said one or a plurality of flexible printed connectors by copper lines or silver lines.

5. The projected capacitive touch panel architecture of claim 4, comprising
said plurality of analog switches being connected to said plurality of sample and hold circuits by electrical wires;
each of said plurality of sample and hold circuits being connected to one of said plurality of analog switches; and
each of said plurality of sensing lines being connected to one of said plurality of analog switches.

6. The projected capacitive touch panel architecture of claim 3, comprising
said plurality of sensing lines being indium tin oxide.

7. The projected capacitive touch panel architecture of claim 3, comprising
said plurality of sensing lines being nano carbon tubes.

8. The projected capacitive touch panel architecture of claim 3, comprising
a triangle waveform being generated by said triangle waveform generator;
said triangle waveform being transmitted from said waveform generator to said plurality of analog switches; and
said triangle waveform being transmitted to said plurality of sensing lines of said touch sensor panel via said plurality of analog switches.

9. The projected capacitive touch panel architecture of claim 8, comprising
said triangle waveform being a triangle waveform alone, or
said triangle waveform being a combination of a triangle waveform and one of any other waveforms.

10. The projected capacitive touch panel architecture of claim 2, comprising
a quantity of said plurality of analog switches being M;
a quantity of said plurality of sample and hold circuits being N; and
1≦M≦N.

11. The projected capacitive touch panel architecture of claim 8, comprising
an input signal controlling said triangle waveform generator;
said input signal being a constant frequency signal;
said input signal being a periodic clock signal from a microcontroller unit (MCU);
said input signal being a square waveform; and
said input signal being established by a firmware design.

12. The projected capacitive touch panel architecture of claim 8, comprising
said triangle waveform comprising an ascending stage and a descending stage;
in said ascending stage, an ascending stage triangle waveform being transmitted to said plurality of sensing lines via said plurality of analog switches;
said ascending stage triangle waveform charging a capacitor at a finger touching location of said touch sensor panel;
in said descending stage, an descending stage triangle waveform being transmitted to said plurality of sample and hold circuits via said plurality of analog switches; and
said descending stage triangle waveform charging said plurality of sample and hold circuits till said plurality of sample and hold circuits being saturated.

13. The projected capacitive touch panel architecture of claim 12, comprising
in said ascending stage, said plurality of sample and hold circuits being in a hold state; and
in said descending stage, said plurality of sample and hold circuits being in a sample state.

14. A projected capacitive touch panel architecture, comprising
a projected capacitive touch circuit;
a touch sensor panel;
a connection between said projected capacitive touch circuit and said touch sensor panel;
said projected capacitive touch circuit comprising a triangle waveform generator, a plurality of analog switches, and a plurality of sample and hold circuits;
a quantity of said plurality of analog switches being M;
a quantity of said plurality of sample and hold circuits being N; and
1≦M≦N.

15. The projected capacitive touch panel architecture of claim 14, wherein said touch sensor panel comprising
a single conductive layer;
said single conductive layer comprising a plurality of sensing lines with high resistance.

16. The projected capacitive touch panel architecture of claim 15, wherein said connection comprising
one or a plurality of flexible printed connectors (FPCs);
said plurality of sensing lines being connected to said one or a plurality of flexible printed connectors by copper lines or silver lines;
said plurality of analog switches being connected to said plurality of sample and hold circuits by electrical wires;
each of said plurality of sample and hold circuits being connected to one of said plurality of analog switches; and
each of said plurality of sensing lines being connected to one of said plurality of analog switches.

17. The projected capacitive touch panel architecture of claim 15, comprising
said plurality of sensing lines being indium tin oxide.

18. The projected capacitive touch panel architecture of claim 15, comprising
said plurality of sensing lines being nano carbon tubes.

19. The projected capacitive touch panel architecture of claim 15, comprising
a triangle waveform being generated by said triangle waveform generator;
said triangle waveform being transmitted from said waveform generator to said plurality of analog switches;
said triangle waveform being transmitted to said plurality of sensing lines of said touch sensor panel via said plurality of analog switches;
said triangle waveform being a triangle waveform alone, or
said triangle waveform being a combination of a triangle waveform and one of any other waveforms;
an input signal controlling said triangle waveform generator;
said input signal being a constant frequency signal;
said input signal being a periodic clock signal from a microcontroller unit (MCU);
said input signal being a square waveform; and
said input signal being established by a firmware design.

20. The projected capacitive touch panel architecture of claim 19, comprising
said triangle waveform comprising an ascending stage and a descending stage;
in said ascending stage, an ascending stage triangle waveform being transmitted to said plurality of sensing lines via said plurality of analog switches;
said ascending stage triangle waveform charging a capacitor at a finger touching location of said touch sensor panel;
in said descending stage, an descending stage triangle waveform being transmitted to said plurality of sample and hold circuits via said plurality of analog switches;
said descending stage triangle waveform charging said plurality of sample and hold circuits till said plurality of sample and hold circuits being saturated;
in said ascending stage, said plurality of sample and hold circuits being in a hold state; and
in said descending stage, said plurality of sample and hold circuits being in a sample state.
